(19) United States
(12) Patent Application Publication
(10) Pub. No.: US 2003/0126971 A1
(43) Pub. Date: Jul. 10, 2003

(54) Timpani base guard

(76) Inventor: Keith Christopher Rawlins, Spring, TX (US)

Correspondence Address: Keith Rawlins, 25311 Tuckahoe Lane, Spring, TX, 77373, US

(21) Appl. No.: 10/041,368

(22) Filed: Jan. 8, 2002

(51) Int. Cl. G10D 13/04

(52) U.S. Cl. 84/419

(57) ABSTRACT

A timpani base guard configured to prevent foreign material from entering a timpani base. The timpani base includes a timpani base cavity and a timpani pedal support. The base guard includes a substantially circular member mounted over the timpani base cavity. The circular member is configured to obstruct foreign material from entering the timpani base cavity. A substantially rectangular member is mounted over the timpani pedal support. The rectangular member is configured to obstruct foreign material from entering the timpani pedal support.

### TECHNICAL FIELD

The present invention relates to an improved timpani drum, and more specifically to a timpani with base guard for preventing foreign material from entering the timpani base.

### BACKGROUND OF THE INVENTION

Modern tunable orchestral timpani drums, also known as kettle drums, generally include a bowl-shaped kettle of copper or brass covered by a drumhead. The tonal pitch of the timpani is varied by adjusting the tension of the drumhead across the shell opening. Often, a foot pedal mechanism located at the base of the timpani is used to vary the tension on the drumhead by moving a metal hoop vertically along the kettle. The foot pedal mechanism typically includes tension cables attached to the metal hoop which extend downward to the timpani base along struts which supporting the kettle.

The timpani is typically tuned to ensure balanced tension along each of the tension cables when the foot pedal is moved. In general, the tension cables are coupled to a tension plate centrally located at the timpani base. Movement of the foot pedal causes the tension plate to move up and down, thereby changing the tension and the tonal pitch of the drum. The timpani is also tuned to produce the full tonal range required by many orchestral pieces. foreign objects, such as dirt, moisture, and other debris, may enter the timpani. Foreign material entering the timpani may cause the timpani to play out of tune, requiring the timpani to go through expensive recalibration to get back into tune. In some cases, it may be impossible to recalibrate the timpani back to its original tonal range. Additionally, dirt and moisture may cause corrosion and damage to the delicate tension-adjusting mechanism of the timpani.

### SUMMARY OF THE INVENTION

In accordance with the present invention, the above and other problems are solved by providing a timpani base guard which prevents debris and other foreign materials from entering a timpani base and pedal support, especially when the timpani drum is used outdoors.

Thus, the present invention generally involves a timpani base guard configured to prevent foreign material from entering a timpani base. The timpani base includes a timpani base cavity and a timpani pedal support. The base guard includes a substantially circular member mounted over the timpani base cavity. The circular member is configured to obstruct foreign material from entering the timpani base cavity. The base guard further includes a substantially rectangular member mounted over the timpani pedal support. The rectangular member is configured to obstruct foreign material from entering the timpani pedal support.

Another aspect of the present invention is a timpani drum having a drum kettle. The drum kettle defines a drum cavity having a kettle opening. A drumhead is positioned above the drum cavity and is stretched across the kettle opening. A drum base is coupled with the drum kettle, with the drum base having a protruding foot pedal portion. The drum base also forms a base cavity. A base cover mounted to the drum base is configured to prevent debris from entering the base cavity.

A further aspect of the present invention is a timpani drum including a drum base defining a base cavity, and means for preventing debris from entering the base cavity.

These and various other features as well as advantages, which characterize the present invention, will be apparent from a reading of the following detailed description and a review of the associated drawings.

### BRIEF DESCRIPTION OF THE DRAWINGS

FIG. 1 shows an exemplary embodiment of a timpani drum in accordance with the present invention.

FIG. 2 shows one embodiment of a base guard contemplated by the present invention.

FIG. 3 shows a cross-sectional view of FIG. 2 along section line 3-3.

FIG. 4 shows another embodiment of the base guard contemplated by the present invention.

### DETAILED DESCRIPTION OF THE INVENTION

The present invention and its various embodiments are described in detail below with reference to the figures. When referring to the figures, like structures and elements shown throughout are indicated with like reference numerals.

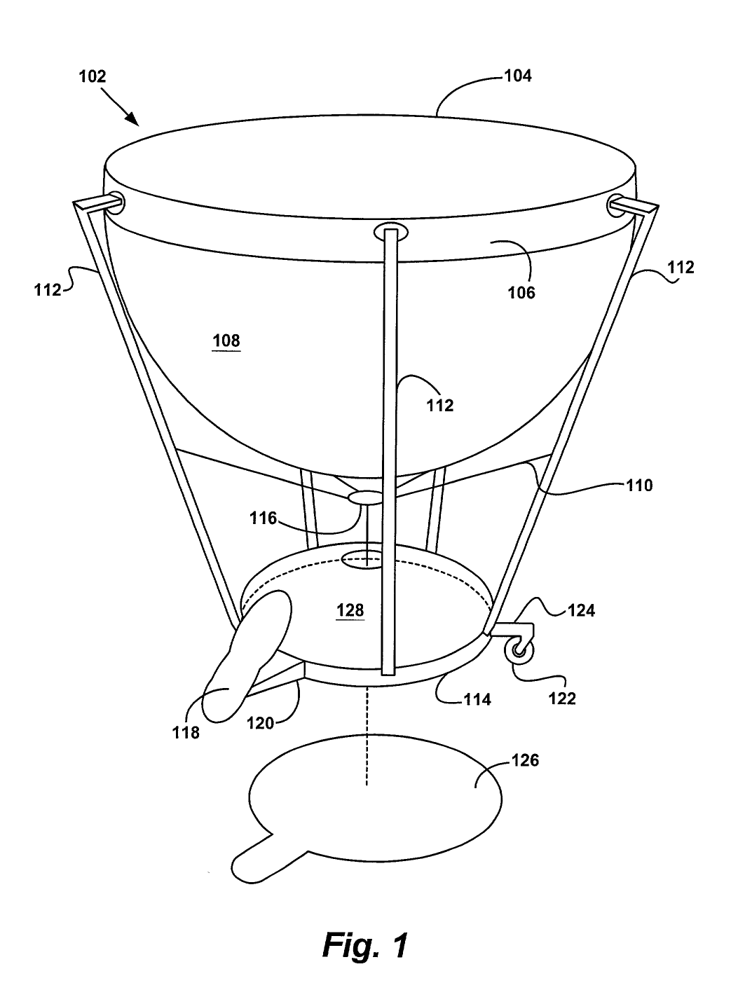

FIG. 1 is an exemplary embodiment of a timpani drum 102 in accordance with the present invention. The timpani drum 102 includes a drumhead 104 typically made of calfskin or synthetic material. The drum head 104 is secured to a metal hoop 106 which encircles a kettle 108. The kettle 108 is typically fabricated from brass, copper, or fiberglass. The hoop 106 is configured to travel vertically along the kettle 108, thereby causing the drumhead 104 to become more or less stretched about the kettle opening. By doing so, the percussion tone of the timpani drum 102 may be varied by controlling the surface tension of the drumhead 104. For example, higher percussion tones are achieved when the hoop 106 is brought lower along the kettle 108 and the surface tension on the drumhead 104 is increased. Conversely, lower percussion tones are achieved when the hoop 106 is brought higher along the kettle 108 and the surface tension on the drumhead 104 is increased decreased.

Generally, tension cables 110 routed along struts 112 are employed to adjust the vertical position of the hoop 106 with respect to the kettle 108. The struts 112 also serve to elevate the kettle 108 above a drum base 114. The tension cables 110 are clamped to the hoop 106 in a conventional manner at one end. At the opposite end, the tension cables 110 converge to a tension plate 116 centered below the kettle 108.

The tension plate 116 is coupled with a protruding foot pedal 118 located at the base 114 of the timpani drum 102. The foot pedal 118 is pivotally attached to a pedal support 120 on the base 114 such that the foot pedal 118 may be pivotally moved up and down by the user. Thus, when the foot pedal 118 is pressed down, the tension plate 116 correspondingly moves down, thereby increasing the percussion tone of the timpani drum 102. Likewise, when the foot pedal 118 is released, the tension plate 116 moves up, thereby decreasing the percussion tone of the timpani drum 102. The base 114 also includes casters 122 mounted along caster supports 124 for easier transport of the timpani drum 102.

In accordance with the present invention, a pan-shaped base guard 126 is mounted to the bottom cavity 128 of the timpani base 114 as shown. The base guard 126 is configured to prevent debris and other foreign materials from entering the timpani base 114 and the pedal support 120, especially when the timpani drum 102 is transported outdoors. As discussed above, foreign materials typically enter the timpani 102 through the base 114 when used in outdoor venues such as stadiums, beaches, or wooded areas. By keeping such foreign materials out of the base 114, the base guard 126 of the present invention helps prevent corrosion and damage to the intricate tension-adjusting mechanism (not shown) of the timpani 102 within the base 114, thereby preserving the useful life of the timpani instrument. Furthermore, the base guard 126 helps reduce or eliminate the number of expensive recalibration procedures needed when the timpani 102 moves out of tune from foreign objects and moisture entering the tension-adjusting mechanism of the timpani 102.

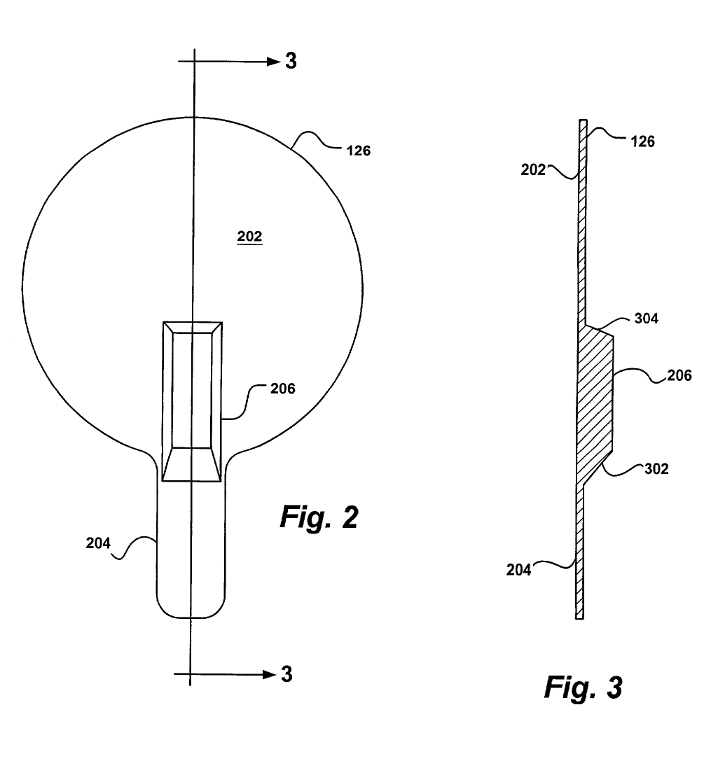

In FIG. 2, one embodiment of the base guard 126 contemplated by the present invention is shown. The base guard is preferably fabricated from a durable material impervious to moisture and small particles, such as metal, plastic, fiberglass, or other suitable material known to those skilled in the art. Alternatively, the base guard 126 may be manufactured from a flexible canvas-type material, such as a flexible plastic or cloth tarp attached at the base 114 of the timpani drum 102.

The base guard 126 is pan-shaped, and includes a substantially circular member 202 and a substantially rectangular member 204, such that the base guard 126 conforms to the undercarriage outline of the timpani base 114. Specifically, the substantially circular member 202 is configured to obstruct debris and other foreign particles from entering the timpani base cavity, while the substantially rectangular member 204 is configured to obstruct debris and other matter from entering the timpani pedal support 120.

Some timpani models, such as the Yamaha 4100 Concert Series, are configured with a tension-adjusting mechanism that requires additional movement clearance by the base guard 126. For such timpani designs, a well 206 is provided for extra movement clearance of the tension-adjusting mechanism. In a particular embodiment of the invention, the well 206 is a rectangular depression partially located on both the substantially circular member 202 and the substantially rectangular member 204. In other embodiments of the base guard 126 the well 206 may be located solely along the substantially circular member 202 or solely along the substantially rectangular member 204. It should be noted that the well 206 may not be required in base guards configured for timpani models without clearance problems.

In FIG. 3, a cross-sectional view of FIG. 2 along section line 3-3 is shown. The well 206 includes a first sidewall 302 proximate the substantially rectangular member 204 and a second sidewall 304 proximate the substantially circular member 202 of the base guard 126. In a particular embodiment of the present invention, the first sidewall 302 is sloped at a smaller angle than the second sidewall 304.

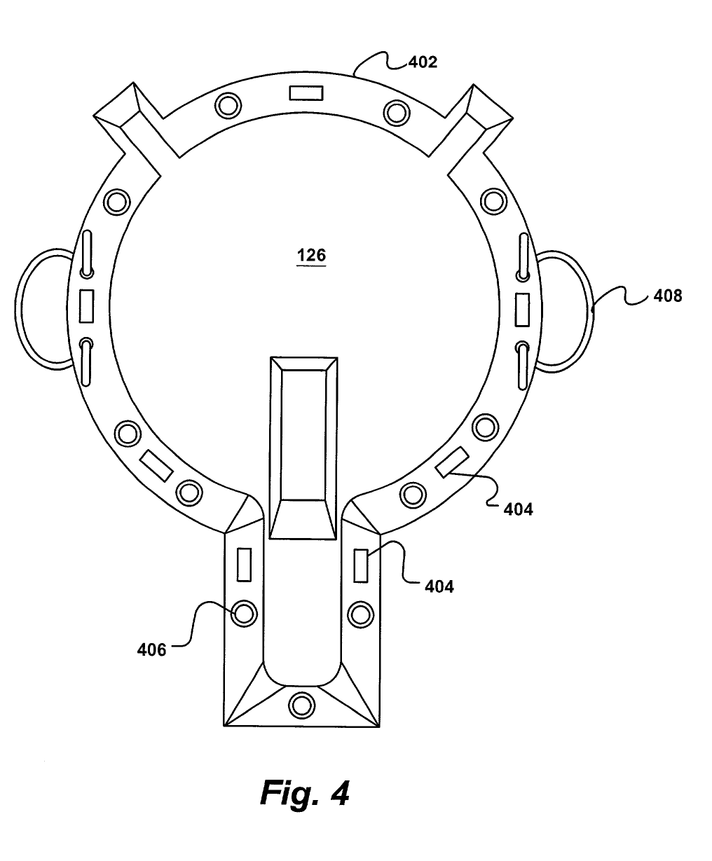

In FIG. 4, an alternative embodiment of the base guard 126 is shown. The base guard 126 is configured with a guard skirt 402 along its perimeter 404. Using the guard skirt 402, the base guard 126 may be removably attached to the timpani base 114 and pedal support 120 by various means well known to those skilled in the art. For example, the guard skirt 402 may include magnets 404 which attach to the timpani base 114 and hold the base guard 126 in place. Alternatively, the guard skirt 402 may include a plurality of receiving holes 406 configured to attach to receiving pins (not shown) along the timpani base 114 and hold the base guard 126 in place. In yet another embodiment of the present invention, elastic bands 408 attached to the guard skirt 402 may be used to hold the base guard 126 in place. Other fastening mechanisms for attaching the base guard 126 to the timpani drum 102 may include latch arrangements or threaded bolts, as will be apparent to one skilled in the art.

Although the invention has been described and illustrated with a certain degree of particularity, it is understood that the present disclosure has been made only by way of example, and that numerous changes, combinations, and arrangements of techniques can be resorted to by those skilled in the art without departing from the spirit and scope of the invention as claimed below.

1. In a timpani drum, a timpani base guard configured to prevent foreign material from entering a timpani base, the timpani base including a timpani base cavity and a timpani pedal support, the base guard comprising:
a substantially circular member mounted over the timpani base cavity, the circular member configured to obstruct foreign material from entering the timpani base cavity; and
a substantially rectangular member mounted over the timpani pedal support, the rectangular member configured to obstruct foreign material from entering the timpani pedal support.

2. The timpani base guard of claim 1, further comprising a well having a first sidewall and a second sidewall.

3. The timpani base guard of claim 2, wherein said first sidewall is sloped at a smaller angle than said second sidewall.

4. The timpani base guard of claim 1, further including a guard skirt attached along the perimeter of the circular member and the rectangular member, the guard skirt overlapping the timpani base.

5. The timpani base guard of claim 4, further including a plurality of receiving holes on the guard skirt for attaching the guard skirt to the timpani base.

6. The timpani base guard of claim 4, further including at least one magnet fastened to the guard skit.

7. The timpani base guard of claim 4, further including at least one elastic band configured to hold the circular member proximate the timpani base.

8. The timpani base guard of claim 1, wherein the base guard is configured to prevent moisture from entering the timpani base.

9. The timpani base guard of claim 1, wherein the base guard is adhesively bonded to the timpani base.

10. The timpani base guard of claim 1, wherein the base guard is magnetically attached to the timpani base.

11. In a timpani drum, a drum kettle defining a drum cavity having a kettle opening, a drumhead positioned above the drum cavity and stretched across the kettle opening, a drum base coupled with the drum kettle, the drum base having a protruding foot pedal portion, the drum base forming a base cavity, the improvement comprising a base cover mounted to the drum base, the base cover configured to prevent debris from entering the base cavity.

12. The timpani drum of claim 11, wherein the base cover comprises:
a substantially circular member mounted over the timpani base cavity, the circular member configured to obstruct debris from entering the base cavity; and
a substantially rectangular member mounted over the timpani pedal support, the rectangular member configured to obstruct debris from entering the foot pedal portion.

13. The timpani drum of claim 11, wherein the base cover is configured to prevent moisture from entering the base cavity.

14. The timpani drum of claim 11, wherein the base cover is adhesively bonded to the drum base.

15. The timpani drum of claim 11, wherein the base cover is magnetically attached to the drum base.

16. The timpani drum of claim 11, wherein the base cover further includes a well having a first sidewall and a second sidewall.

17. The timpani drum of claim 16, wherein said first sidewall is sloped at a smaller angle than said second sidewall.

18. The timpani drum of claim 11, further comprising a guard skirt attached along the perimeter of the base cover.

19. A timpani drum comprising:
a drum base defining a base cavity; and
means for preventing debris from entering the base cavity.
